(19) United States
(12) Patent Application Publication
(10) Pub. No.: US 2026/0359711 A1
(43) Pub. Date: Nov. 12, 2026

(54) SYSTEMS AND METHODS FOR DEPLOYING A MODEL IN A SERVING SYSTEM TO MANAGE REQUEST TRAFFIC MADE IN A NETWORK

(71) Applicant: Capital One Services, LLC, McLean, VA (US)

(72) Inventors: Li WANG, McLean, VA (US); Sahil BADYAL, Fairfax, VA (US); Nicholas LAMM, Croton on Hudson, NY (US)

(73) Assignee: Capital One Services, LLC, McLean, VA (US)

(21) Appl. No.: 19/201,887

(22) Filed: May 7, 2025

(51) Int. Cl. G06N 20/00; G06F 9/54

(52) U.S. Cl. CPC G06N 20/00; G06F 9/547

(57) ABSTRACT

A device may invoke a generative model using a plurality of inputs based on a sequence of elements to generate a plurality of reasoning traces. An input may indicate an element of the sequence, and cumulative reasoning traces generated for any previous inputs. The device may generate, based on the reasoning traces, a synthetic dataset that indicates a reasoning trajectory for the sequence. The device may execute a process for adjusting parameters of a production model using the synthetic dataset. The device may receive, from a user device, a request for an outcome. The device may determine, using the request for the outcome and the production model, one or more communication actions to execute to achieve the outcome. The device may execute the communication actions to generate a response to the request. The device may transmit, to the user device, the response to the request.

### BACKGROUND

A server may receive request messages from a user device over a network. The request messages indicate the data that is being requested by the user device. The server may generate data responsive to the request messages, and transmit response messages containing the data to the user device, over the network, to satisfy the requests of the user device. The user device may repeatedly transmit request messages if the response messages from the server contain insufficient, irrelevant, or otherwise unsatisfactory data with respect to the user device's requests. This cycle of request and response uses significant computing resources of the server and the user device in connection with message generation, as well as significant network resources in connection with message communication.

### SUMMARY

Methods and systems are described herein for novel uses and/or improvements to artificial intelligence applications. As one example, methods and systems are described herein for managing request traffic from user devices using a production model that produces high-quality outputs that reduce the overall number of requests and responses that are exchanged with the user devices.

A serving system may manage requests from user devices. When a user device sends a request message over a network, the serving system processes this request and generates a response message. This response is then transmitted back to the user device to fulfill its request in real-time. For example, the user device's request may indicate particular data or a particular action that is desired by the user device, and the serving system may generate the data or perform the action and transmit a response that contains the data or an indication that the action was performed. However, if the response contains insufficient, irrelevant, or otherwise unsatisfactory data, or indicates that an undesired action was performed, the user device may repeatedly send additional request messages until its demands are fully met. This continuous cycle of request and response requires substantial computing power from both the serving system and the user device for generating and processing messages, and additionally requires significant network resources to handle the communication of these messages. Furthermore, the serving system may expend significant amounts of processing resources performing undesired actions.

In some examples, the serving system may generate data for a response to a request from a user device by providing an input into a model. However, the model may produce an output without the use of reasoning. This may result in a low-quality output due to the model generating the output with limited or no analysis of context, relationships, or coherence. Accordingly, the output may be inconsistent, irrelevant, or factually incorrect. Additionally, the absence of reasoning prevents the model from refining its responses based on intermediate conclusions, resulting in the output being incomplete or lacking in depth. Furthermore, such a model may struggle to handle complex queries requiring multi-step processing, logical deduction, or adaptive decision-making, thereby reducing its effectiveness in tasks that demand contextual understanding and precision. Due to the low quality of the output, the user device may make additional requests in order to satisfy its demands, which results in additional processing by the serving system, and additional consumption of network resources to communicate the requests and the responses. Moreover, the follow-up requests from the user device may contain extensive data designed to steer the model to producing the desired outputs for the user device. This extensive data consumes significant processing resources of the serving system and is communicated with additional network resources. However, training the model to use reasoning may require the use of large datasets that contain many reasoning examples. Such datasets may be in limited supply, resulting in the model being insufficiently trained and unable to produce highly accurate and relevant outputs using reasoning.

To overcome these technical deficiencies, methods and systems disclosed herein use synthetic data to train a production model to use reasoning and actions (e.g., requesting data from an external source) to produce an output, thereby sufficiently training the model to use reasoning to produce highly accurate and relevant outputs. The synthetic data may be generated using a generative model. For example, the generative model may be invoked using a plurality of inputs based on a sequence of elements, to thereby cause the generative model to generate a plurality of reasoning traces in response to the inputs. Each input may indicate an element of the sequence, and cumulative reasoning traces generated for any previous inputs of the plurality of inputs. Thus, a progressive prompting approach may be used, whereby an output (e.g., a reasoning trace) from a previous step is included as input in subsequent steps, thereby incrementally building the reasoning traces. By using cumulative reasoning traces that successively grow at each input to the generative model, contextual continuity is maintained for the generative model, thereby producing highly contextually relevant outputs from the generative model.

The synthetic dataset can be constructed from the reasoning traces generated for the sequence. For example, the synthetic dataset may include a reasoning trajectory based on the reasoning traces that indicates the reasoning that could be used by a model from a start to an end of the sequence. In this way, a vast amount of quality synthetic data can be built to train (e.g., fine tune) the production model. The trained production model can then be deployed in a serving system for online, real-time handling of requests from user devices.

Due to being trained on a vast amount of high-quality synthetic data, the production model may be able to generate relevant and efficient actions that can achieve the outcomes requested by the user devices. Moreover, because the production model may be smaller (in terms of number of parameters) than the generative model used to generate the synthetic data, the production model may generate outputs with low latency suitable for online requests received at the serving system. The production model, based on its training, may use reasoning and actions to generate outputs for the requests from the user devices. The actions may be communication actions involving the serving system communicating with other systems (e.g., via web pages, web services, databases, or the like) to retrieve data or perform actions in furtherance of the requested outcomes.

The serving system can generate responses, which are based on the results of the communication actions, that provide high-quality, relevant data to the user devices and/or that indicate that relevant actions were performed. Providing high-quality data and/or performing relevant actions to the requests minimizes follow-up requests, thereby reducing the overall number of requests and responses that are exchanged. Thus, by delivering precise and contextually appropriate information on the first attempt, the serving system avoids redundant interactions that would otherwise be required to refine or correct the outputs. This efficiency improves system performance by lowering processing and network overhead, reducing latency, and optimizing resource utilization.

In some aspects, the system may retrieve, from one or more servers, a dataset that indicates a sequence of elements. The system may invoke a generative model using a plurality of inputs based on the sequence to generate a plurality of reasoning traces, where an input, of the plurality of inputs, indicates an element of the sequence, and cumulative reasoning traces generated for any previous inputs of the plurality of inputs. The system may generate, based on the plurality of reasoning traces, a synthetic dataset that indicates a reasoning trajectory for the sequence. The system may execute a process for adjusting parameters of a production model using the synthetic dataset. The system may deploy, to a serving system, the production model with adjusted parameters for handling network requests from user devices. The system may receive, from a user device, a network request indicating a request for an outcome. The system may invoke the production model using the request for the outcome to determine one or more communication actions to execute to achieve the outcome. The system may execute the one or more communication actions to generate a response to the request. The system may transmit, to the user device, a network response indicating the response to the request.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIGS. 1A-1F shows an example environment for deploying a model in a serving system, in accordance with one or more embodiments.

FIG. 2 shows illustrative components for a system used to manage request traffic, in accordance with one or more embodiments.

FIG. 3 shows a flowchart of the steps involved in managing request traffic in a system, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

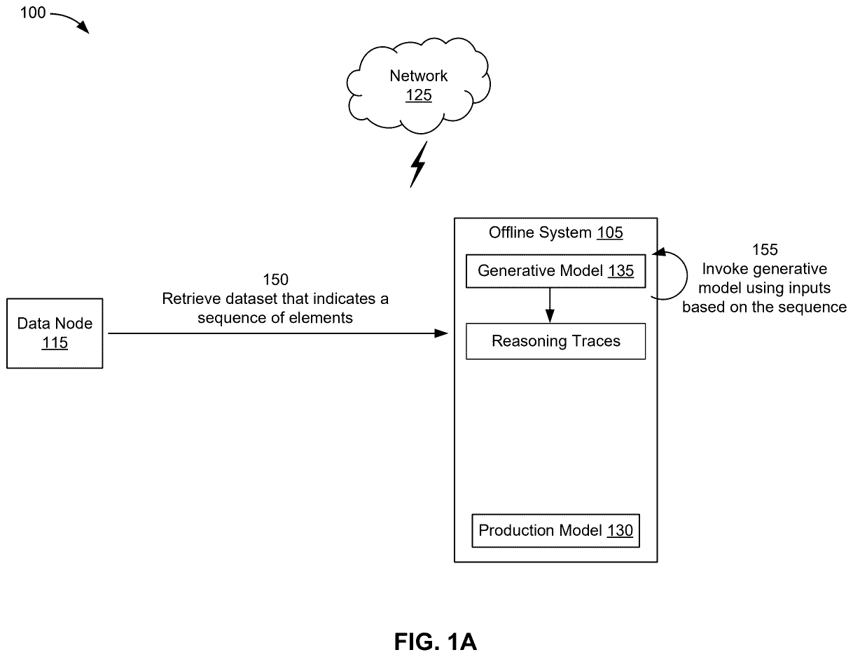

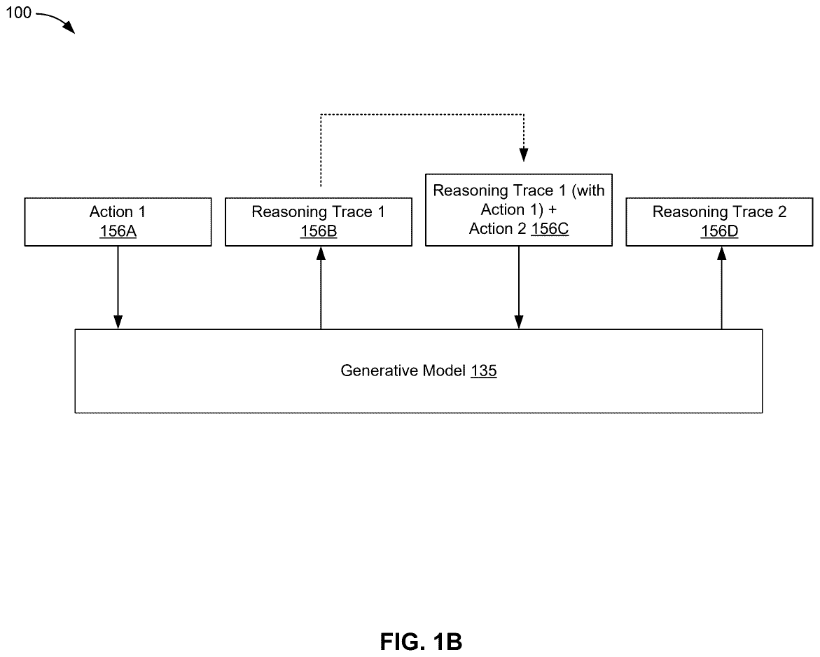

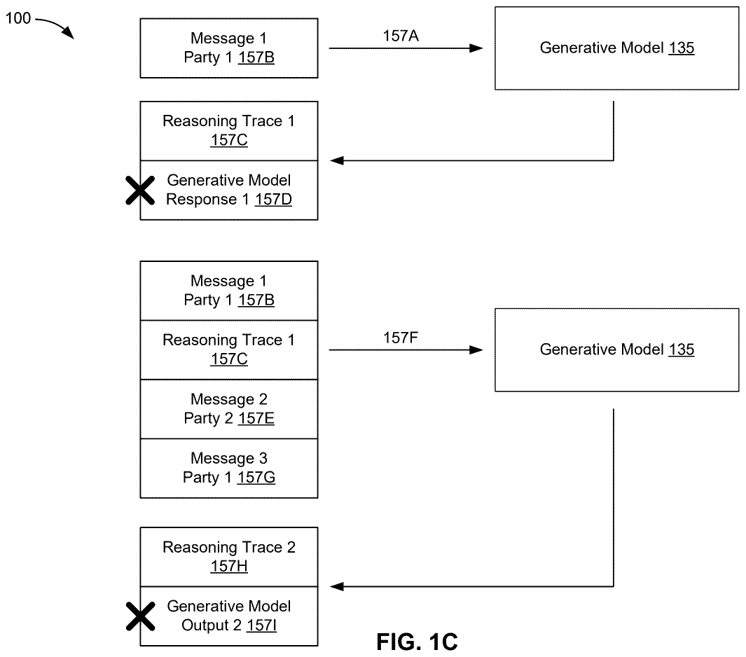

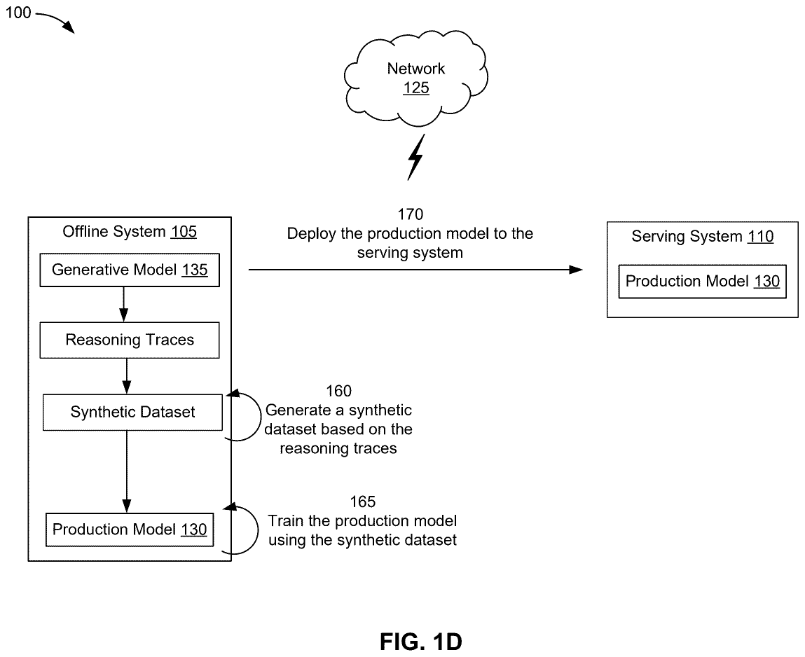

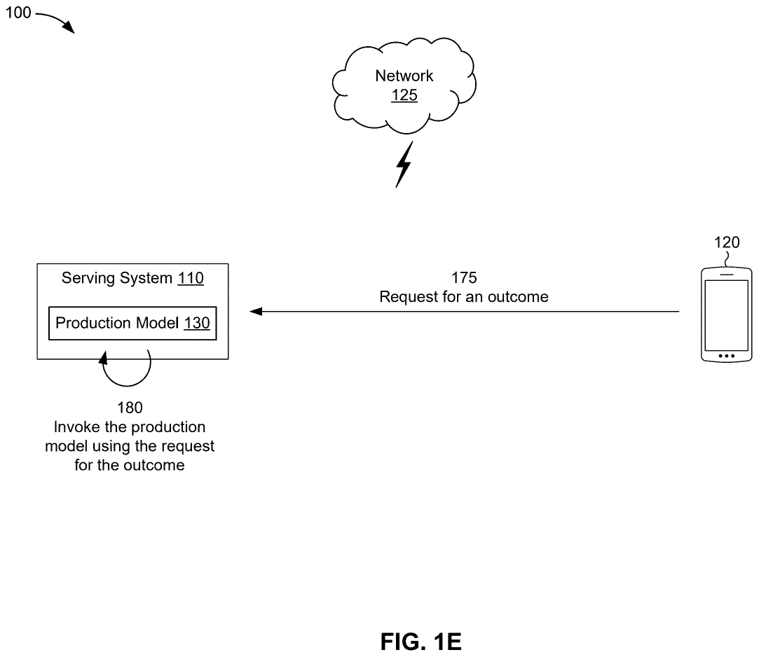

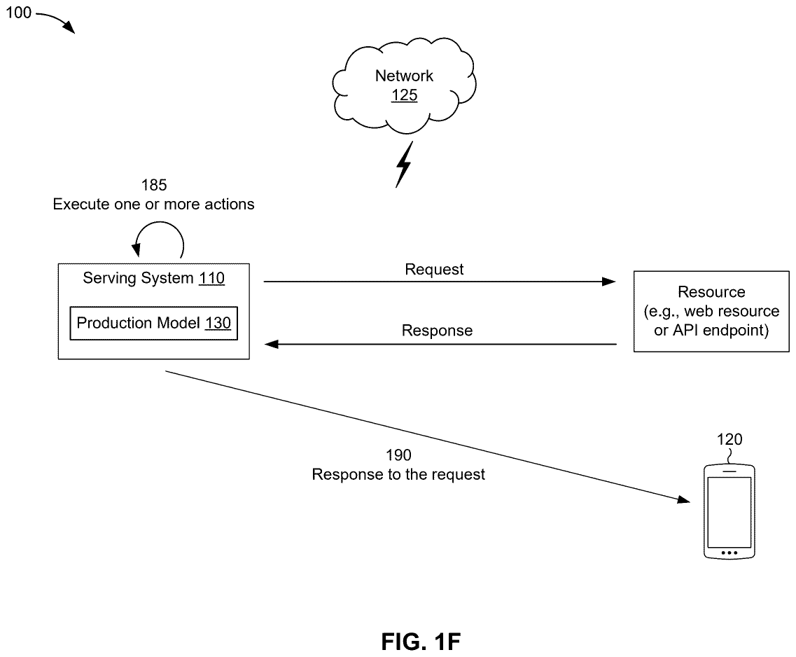

FIGS. 1A-1F show an example environment 100 for deploying a model in a serving system, in accordance with one or more embodiments. As shown, the environment 100 includes an offline system 105, a serving system 110, a data node 115, a user device 120, and a network 125.

Communication among the devices and systems of environment 100 may be performed via the network 125. The network 125 may include one or more wired and/or wireless networks. For example, the network 125 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. In some embodiments, where the offline system 105 and the serving system 110 are components of the same higher-level system, the offline system 105 and the serving system 110 may communicate without use of the network 125.

The data node 115 may include storage, one or more data sources, one or more data services (e.g., accessible via an application programming interface (API)), and/or one or more databases, among other examples. The data node 115 may include, or may be included in, one or more servers. The data node 115 may store information relating to sequences (e.g., sequences of actions or historical text interactions) or synthetic data, among other examples. The data node 115 may provide any of the aforementioned information to the offline system 105 and/or to the serving system 110 (e.g., via the network 125). In some embodiments, communications of the data node 115 with the offline system 105 and/or the serving system 110 may be performed locally (e.g., within a cloud computing environment) rather than through the network 125.

The user device 120 may include a communication device and/or a computing device. For example, the user device 120 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 120 may implement a user interface facilitating user-computer interaction and communication, and may include display screens, keyboards, a mouse, and the appearance of a desktop. For example, a user interface may include a way a user interacts with an application or a website. In some embodiments, the user interface may be a question-answer system, or chatbot, user interface. The user device 120 may exchange data with the serving system 110. For example, data exchanged with the serving system 110 may be in connection with the user device 120 accessing a web page using a web browser installed on the user device 120.

The offline system 105 may include a communication device and/or a computing device. For example, the offline system 105 may include one or more physical servers, one or more virtual servers (e.g., executing on computing hardware), and/or cloud computing resources (e.g., executing on computing hardware used in a cloud computing environment). “Offline” may refer to an environment in which the execution of data processing tasks is performed independently from real-time user inputs.

The serving system 110 may include a communication device and/or a computing device. For example, the serving system 110 may include one or more physical servers, one or more virtual servers (e.g., executing on computing hardware), and/or cloud computing resources (e.g., executing on computing hardware used in a cloud computing environment). In some embodiments, the serving system 110 may be implemented on an edge node of a network or of a cloud system (e.g., in a regional data center of the cloud system). In some embodiments, the serving system 110 may be a component (e.g., a hardware component or a software component) of the user device 120. In some embodiments, the serving system 110 may provide question-and-answer system, or chatbot, functionality, whereby a user device 120 provides questions or other prompts to the serving system 110, and the serving system 110 provides responses in a conversational format. In some embodiments, the serving system 110 may be included in a robotic system (e.g., a robot, a humanoid robot, a robotic arm, or the like), whereby a user device 120 or other control device, provides text-based or speed-based instructions indicating physical movements of the robotic system to the serving system 110, and the serving system 110 causes the robotic system to perform the physical movements.

The serving system may be configured to manage request traffic from user devices 120 made via the network 125. The serving system 110 may be an online system. “Online” may refer to an environment in which the execution of data processing tasks are performed in response to real-time user inputs. For example, the serving system 110 may provide responses to requests from user devices 120 in real time. “Real time” may refer to the responses being provided within a time frame (e.g., within 2 seconds, within 1 second, or within 100 milliseconds) that is perceptibly concurrent or near-concurrent with the requests.

In some embodiments, communications between the offline system 105 and the serving system 110 may be performed through the network 125. For example, the offline system 105 may be a centralized processing system located on dedicated server(s) or cloud computing environment(s) that have a significant amount of computing resources, to perform the actions described below, that are not available or at least cannot be routinely utilized by the serving system 110 in the same way. The offline system 105 may communicate with and perform the same role for multiple serving systems 110 that may be distributed in different geographic areas and/or communicate with different groups of user devices 120. In this way, the offline system 105 may reduce the processing resources that are utilized compared to, for example, each serving system 110 having to have the same actions performed by a dedicated offline system.

In other embodiments, communications between the offline system 105 and the serving system 110 may be performed locally (e.g., within a cloud computing environment) rather than through the network 125. For example, the offline system 105 and the serving system 110 may be implemented in the same cloud computing resource or in separate cloud computing resources within the same cloud computing environment. In some embodiments, the offline system 105 and the serving system 110 may be components (e.g., co-located components or distributed components) of the same higher-level processing system. For example, the offline system 105 and the serving system 110 may be hardware components or software components of the same system.

The offline system 105 may perform training (e.g., fine tuning) of a production model 130 using a generative model 135. The production model 130 and/or the generative model 135 may be machine learning models. For example, the production model 130 and/or the generative model 135 may be language models. As referred to herein, a “language model” may comprise a computational system designed to understand and generate human language through learning patterns in vast amounts of training data, such as books, websites, and other sources. The trained model may be able to predict and produce coherent and contextually relevant text based on input it receives. In some examples, a language model may include a large language model (LLM), a transformer model, a generative pre-trained transformer (GPT) model, or another type of generative model. The production model 130 may be smaller than the generative model 135 (in terms of number of parameters). For example, the generative model 135 may utilize five billion or more parameters, while the production model 130 may utilize one billion or fewer parameters.

The offline system 105 may train the production model 130 to generate responses to requests that follow a reasoning and acting (ReAct) framework. In accordance with the ReAct framework, a response to a request (e.g., a prompt or a query) may include three components: a planning step (sometimes referred to as a “thought”), an action, and a result (sometimes referred to as an “observation”). The planning step may include a reflection on the request that identifies which action to perform in response. The action may be selected from a set of available actions. The action may be a tool or a function that can be invoked, such as querying an application programming interface (API) (e.g., to retrieve account information or to submit a change to an account). Execution of the action may return the result. As an example, for the request “I want to check my account balance,” the planning step may include the reflection of “to check an account balance, I need to know which account to check,” the action may include transmitting an API request for a list of accounts, and the result may be the list of accounts including a first account ending in 1234 and a second account ending in 5678. Continuing with the example, based on the result, the response to the request may be “Would you like to check the balance of the account ending in 1234 or the account ending in 5678?”

By training the production model 130 in accordance with the ReAct framework, the production model 130 may produce high-quality outputs and/or perform actions with high relevance to requests from user devices 120, thereby reducing the number of network requests and responses that would otherwise be exchanged if low-quality outputs were produced and/or irrelevant actions were performed. To sufficiently train the production model 130 to use the ReAct framework, a vast amount of data indicating requests annotating with their corresponding planning steps, actions, and results may be needed. However, such data may be available only in limited quantities. Accordingly, the offline system 105 may train the production model 130 using a synthetic dataset generated by the generative model 135, as described herein. When trained in a particular domain with the synthetic dataset, the production model 130 may produce outputs matching that of the generative model 135, despite the production model 130 being much smaller.

As shown in FIG. 1A, and by reference number 150, the offline system 105 may retrieve a dataset that indicates a sequence of elements. The dataset may indicate a plurality of sequences of elements, but the description herein is in terms of a single sequence of elements for simplicity. The offline system 105 may retrieve the dataset from the data node (e.g., via an API request). The dataset may include historical data, may be editorially generated, and/or may be generated using a model (e.g., a machine learning model), such as generative model 135.

In some embodiments, the sequence of elements may indicate a sequence of actions to achieve a particular outcome (e.g., each element is a different action). As an example, if the outcome is to check an account balance, then the sequence of actions may include retrieving available accounts, asking for a selection of an account to check, and checking the selected account. The sequence of actions may be pre-generated (e.g., editorially generated or generated using a model). Using a pre-generated sequence of actions may help to resolve cold start issues associated with generating the synthetic dataset.

In some embodiments, the sequence of elements may indicate messages of a historical text interaction (e.g., each element is a different message). For example, the historical text interaction may be between two parties (e.g., a user and an entity providing a service to the user). In some examples, one of the parties may be a chatbot or another type of conversational agent that uses artificial intelligence. The historical text interaction may be a chat interaction, a series of emails (e.g., an original email and subsequent reply emails), a telephone or video interaction transcribed to text, or the like.

As shown by reference number 155, the offline system 105 may invoke the generative model 135 using a plurality of inputs based on the sequence, thereby causing the generative model 135 to generate a plurality of reasoning traces in response to the inputs. For example, the offline system 105 may generate the reasoning traces using the generative model 135. A “reasoning trace” may include the planning step, the action, and/or the result corresponding to an element of the sequence. In examples where the sequence indicates actions to achieve a particular outcome, a reasoning trace for an action may include the planning step and/or the result (e.g., because the action is already known), and in some examples may also include the user request that could elicit the planning step, the action, and the result. In examples where the sequence indicates messages of a historical text interaction, a reasoning trace for a message (e.g., a user request) may include the planning step and/or the action, and in some examples may also include the result.

The offline system 105 may invoke the generative model 135 sequentially using the inputs, and each input may sequentially indicate (e.g., based on the sequence) an element (e.g., action or message) of the sequence, and the cumulative reasoning traces generated for any previous inputs. For example, a first input may indicate a first element of the sequence, a second input may indicate the reasoning trace generated in response to the first input and a second element of the sequence, a third input may indicate the reasoning trace generated in response to the first input, the reasoning trace generated in response to the second input, and a third element of the sequence, and so forth. An input may be in the form of a prompt for the generative model 135. For example, an input may instruct the generative model 135 to output a reasoning trace based on a given element of the sequence and any cumulative reasoning traces already generated.

The offline system 105 may invoke (e.g., sequentially) the generative model 135 in a series of steps. For example, the offline system 105 may generate a first input based on a first element (e.g., action or message) of the sequence, and invoke the generative model 135 using the first input. The first input may include a first instruction to generate a first reasoning trace based on the first element. Continuing with the example, the offline system 105 may generate a second input based on a second element of the sequence, and invoke the generative model 135 using the second input. The second input may include the first reasoning trace and a second instruction to generate a second reasoning trace based on the second element. This procedure may continue until the end of the sequence is reached. Thus, the offline system 105 utilizes a progressive prompting approach when invoking the generative model 135, such that an output (e.g., a reasoning trace) from a previous step is included as input in subsequent steps, thereby incrementally building the reasoning traces.

As shown in FIG. 1B, in examples where the sequence indicates actions to achieve a particular outcome, the offline system 105 may invoke the generative model 135 using a first input 156A based on a first action of the sequence (e.g., “retrieving available accounts”), and generate, using the generative model 135 and based on the first input 156A, a first reasoning trace 156B. The first reasoning trace 156B may indicate a first planning step (“to check an account balance, I need to know which account to check”) and a first result (e.g., a list of accounts) corresponding to the first action. In some examples, a first request that could correspond to the first action may also be generated (e.g., “I want to check my account balance”), for example, as part of the first reasoning trace. The offline system 105 may then invoke the generative model 135 using a second input 156C based on the first reasoning trace and a second action of the sequence (e.g., “asking for a selection of an account to check”), and generate, using the generative model 135 and based on the second input 156C, a second reasoning trace 156D. The second reasoning trace 156D may indicate a second planning step and a second result corresponding to the second action. In some examples, a second request that could correspond to the second action may also be generated, for example, as part of the second reasoning trace 156D. This procedure may continue until the end of the sequence is reached.

As shown in FIG. 1C, in examples where the sequence indicates messages of a historical text interaction, the offline system 105 may invoke the generative model 135 using a first input 157A based on a first message 157B of the sequence (“I want to check my account balance”), and generate, using the generative model 135 and based on the first input 157A, a first reasoning trace 157C. The first message 157B may be associated with a first party to the interaction. The first reasoning trace 157C may indicate a first planning step (“to check an account balance, I need to know which account to check”) and a first action (“retrieving available accounts”) corresponding to the first message. In some examples, a first result (e.g., a list of accounts) of the first action may also be generated, for example, as part of the first reasoning trace. To prevent the generative model 135 from excessively generating planning steps and actions for the first reasoning trace, the first input may also indicate a maximum number of reasoning cycles that are to be used and/or the generative model 135 may be allowed to generate planning steps and actions until generating a response to the first message (e.g., provided that the maximum number of reasoning cycles is not reached in doing so). Thus, generating the first reasoning trace may also include generating (e.g., using the first result) a response 157D to the first message 157B (“Would you like to check the balance of the account ending in 1234 or the account ending in 5678?”). The offline system 105 may discard the response 157D, and insert a second message 157E of the sequence associated with a second party to the interaction (e.g., “Sure, I can provide the balance for account *2345 or account *3456”) in place of the response 157D. In this way, the actual responses of the second party are used, rather than the responses generated by the generative model 135, thereby preserving the actual historical text interaction, which improves the quality of the reasoning traces that are generated.

The offline system 105 may then invoke the generative model 135 using a second input 157F based on the first message 157B of the sequence (from the first party), the first reasoning trace 157C, the second message 157E of the sequence (from the second party), and a third message 157G of the sequence (from the first party), and generate, using the generative model 135 and based on the second input 157F, a second reasoning trace 157H. The second reasoning trace 157H may indicate a second planning step and a second action corresponding to the third message. In some examples, a second result of the second action may also be generated, for example, as part of the second reasoning trace 157H. As described above, the generative model 135 may be permitted to generate planning steps and actions for the second reasoning trace 157H until a maximum number of reasoning cycles is reached or a response to the third message 157G is generated. Thus, generating the second reasoning trace 157H may also include generating (e.g., using the second result) a response 157I to the third message 157G, which the offline system 105 may discard and replace with a fourth message (not shown) of the sequence, in a similar manner as described above.

Thus, the reasoning traces may be generated for each message of the first party, and the responses that are generated may be replaced with the actual response messages of the second party. This procedure may continue until the end of the sequence is reached. A message of a sequence may be in multiple message parts that were provided consecutively by one party (e.g., a turn), which are then followed by a message (e.g., one or more message parts) provided by the other party (e.g., a next turn).

As shown in FIG. 1D, and by reference number 160, the offline system 105 may generate a synthetic dataset, based on the generated reasoning traces, that indicates a reasoning trajectory for the sequence. For example, the offline system 105 may combine the generated reasoning traces (e.g., in chronological order) to generate the reasoning trajectory for the sequence. The synthetic dataset may be synthetic in that it is generated by the generative model 135, and may include hallucinations of the generative model 135 where real data is unknown (e.g., the quantity of accounts, the account numbers of the accounts, etc.). The synthetic dataset generated by the offline system 105 may include the reasoning trajectories for multiple sequences. A “reasoning trajectory” may refer to the sequential reasoning traces for a sequence that together reach an outcome or conclude an interaction.

As shown by reference number 165, the offline system 105 may train (e.g., fine tune) the production model 130 using the synthetic dataset (e.g., that is stored in and retrieved from the data node 115). For example, the offline system 105 may execute a process for adjusting parameters of the production model 130 using the synthetic dataset. In some examples, the offline system 105 may process the synthetic dataset to extract linguistic patterns and contextual relationships. The process for adjusting parameters of the production model 130 may include iterative training cycles. For example, through the iterative training cycles, the offline system 105 may employ techniques such as masked language modeling or next-token prediction to adjust the parameters of the production model 130. During each cycle, predictions of the production model 130 may be compared against the actual text sequences in the synthetic dataset to calculate loss functions, guiding optimization algorithms in updating weights of the production model 130. The process may continue until the production model 130 achieves a desired level of performance, enabling the production model 130 to generate coherent and contextually relevant text based on the learned patterns.

As shown by reference number 170, the offline system 105 (or a higher level system that includes the offline system 105 and the serving system 110) may deploy the production model 130 that has been trained (e.g., fine tuned) to the serving system 110. For example, the offline system 105 may provide (e.g., transmit) the production model 130 to the serving system 110. Deploying the production model 130 may include converting the production model 130 into a deployment format, such as by transforming the parameters and architecture of the production model 130 into a binary format. Deploying the production model 130 may also include loading (e.g., installing) dependencies and libraries for the production model 130 in the serving system 110. Deploying the production model 130 may further include loading (e.g., installing) the production model 130 (e.g., in the deployment format) in the serving system 110. In some embodiments, the serving system 110 may implement an API used to handle incoming requests and pass them to the production model 130 for inference. The API may be existing at a time of the deployment of the production model 130, or deploying the production model 130 may include configuring and loading API components for the production model 130. In the serving system 110, the production model 130 may be used to handle network requests from user devices 120. Additionally, or alternatively, in the serving system 110 (e.g., included in a robotic system), the production model 130 may be used to handle instructions indicating physical movements of the robotic system made by a user device 120 or other control device.

As shown in FIG. 1E, and by reference number 175, the serving system 110 may receive, from the user device 120 via the network 125, a network request (e.g., an HTTP request) indicating a request for an outcome. An “outcome” may refer to a result, a response, or an effect that is to be generated, returned, or performed by the serving system 110. For example, the request for the outcome may indicate particular data that is to be returned (“What is the balance of my account”) and/or may indicate a particular action that is to be performed (“I would like to close my account”). In some examples, the request for the outcome may request computing resources to be allocated for the user device 120, may request execution of code by the serving system 110, may request execution of a database query by the serving system 110 to insert or retrieve data from a database, or may request adjustment, issuance, or cancellation of a security credential associated with the user device 120. As another example, the request for the outcome may indicate a particular physical movement command for a robotic system (“Bring me my shoes”).

As shown by reference number 180, the serving system 110 may invoke the production model 130 using the request for the outcome as input, thereby causing the production model 130 to generate a response using reasoning (e.g., to generate a reasoning trace having a planning step, an action, and/or a result). For example, the reasoning may indicate one or more actions, such as communication actions, to execute in order to achieve the outcome. A “communication action” may refer to an action in which the serving system 110 communicates (e.g., transmits and/or receives information) with another device. Accordingly, by invoking the production model 130, the serving system 110 may determine one or more actions (e.g., communication actions) to execute to achieve the outcome. Due to being trained on the synthetic data, the production model 130 may be able to generate relevant and efficient actions that can achieve the outcome, and the production model 130 may do so with low latency suitable for online requests received at the serving system 110. The high-quality data and/or actions generated by the production model 130 facilitates fewer request and response cycles between the serving system 110 and the user device 120 than would otherwise occur if less relevant and efficient actions were generated, thereby conserving processing resources and network resources.

In a robotic system, the input to the production model 130 may include the request for the outcome and a textual description of one or more scenes captured by one or more cameras internal to and/or external to the robotic system. For example, the serving system 110 may obtain image data from a camera, and process the image data through an image-to-text model to generate a textual description. The image-to-text model may be a combination of a convolutional neural network (e.g., a vision transformer) and a recurrent neural network (e.g., a generative language model). Thus, for the robotic system, the actions generated by the production model 130 may be physical movement commands for the robotic system. In a similar manner as described above, these physical movement commands may be highly efficient, thereby reducing processing demands on the robotic system, more efficiently utilizing allocated resources of the robotic system, and producing less wear on the robotic system.

In some examples, to determine the one or more actions, the serving system 110 may determine one or more data sources to query for information. Thus, communication actions in this example may include transmitting one or more queries to the one or more data sources. A query may include an HTTP request, an API request, a database query or the like. A data source may include a search engine, a web service, a database, a cloud storage system, or a local file system, among other examples.

As shown in FIG. 1F, and by reference number 185, the serving system 110 may execute the one or more actions (e.g., communication actions) to generate a response to the request. Executing the one or more actions may include transmitting a server-side request to a resource, and receiving a server-side response from the resource. The server-side request may request particular data and/or may request performance of a particular action or execution of a particular process. The server-side response may provide the requested data and/or may provide confirmation that the action was performed or the process was executed. The server-side request/response may be an HTTP request/response and the resource may be a web resource (e.g., a web-based search engine), or the server-side request/response may be an API request/response and the resource may be an API endpoint, among other examples.

Executing the actions may be to achieve the outcome indicated by the request. For example, executing the actions may retrieve relevant data for the user device 120 and/or may cause a relevant action to be performed or a relevant process to be executed. As an example, transmitting the server-side request may cause execution of an action that makes changes to an account associated with the user device. In some examples, executing the actions may allocate computing resources for the user device 120, may execute code, may execute a database query to insert or retrieve data from a database, or may adjust, issue, or cancel a security credential associated with the user device 120. For example, transmitting the server-side request may cause adjustment, issuance, or cancellation of a security credential associated with the user device 120. In some examples, executing the actions may cause a robotic system to perform a physical movement. The response to the request may indicate the actions that were performed, may indicate that the outcome was achieved, and/or may indicate data (e.g., results) obtained by executing the actions.

As shown by reference number 190, the serving system 110 may transmit, via the network 125, a network response (e.g., an HTTP response) indicating the response to the request to the user device 120. By using the production model 130, trained by the synthetic data generated by the generative model 135, the serving system 110 is able to provide high-quality, relevant data to the user device 120 and/or perform relevant and efficient actions to achieve the outcome requested by the user device 120. In this way, the serving system 110 is able to satisfy the demands of the user device 120 in an efficient, low-latency manner that conserves processing resources and network resources.

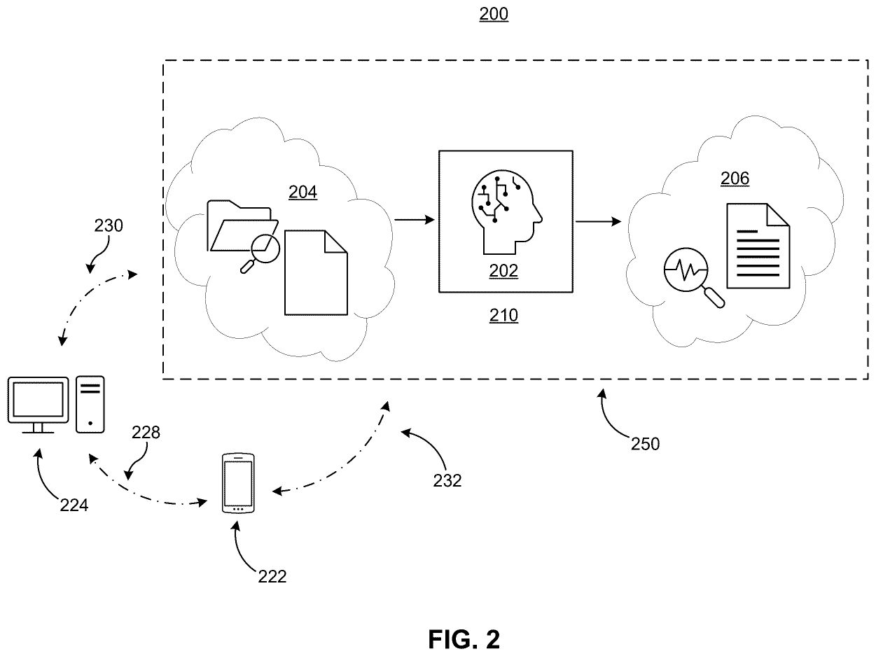

FIG. 2 shows illustrative components for a system used to manage request traffic, in accordance with one or more embodiments. For example, FIG. 2 may show illustrative components for communicating requests and high-quality responses to the requests. As shown in FIG. 2, system 200 may include mobile device 222 and user terminal 224. While shown as a smartphone and personal computer, respectively, in FIG. 2, it should be noted that mobile device 222 and user terminal 224 may be any computing device, including, but not limited to, a laptop computer, a tablet computer, a hand-held computer, and other computer equipment (e.g., a server), including “smart,” wireless, wearable, and/or mobile devices. FIG. 2 also includes cloud components 210. Cloud components 210 may alternatively be any computing device as described above, and may include any type of mobile terminal, fixed terminal, or other device. For example, cloud components 210 may be implemented as a cloud computing system, and may feature one or more component devices. It should also be noted that system 200 is not limited to three devices. Users may, for instance, utilize one or more devices to interact with one another, one or more servers, or other components of system 200. It should be noted, that, while one or more operations are described herein as being performed by particular components of system 200, these operations may, in some embodiments, be performed by other components of system 200. As an example, while one or more operations are described herein as being performed by components of mobile device 222, these operations may, in some embodiments, be performed by components of cloud components 210. In some embodiments, the various computers and systems described herein may include one or more computing devices that are programmed to perform the described functions. Additionally, or alternatively, multiple users may interact with system 200 and/or one or more components of system 200. For example, in one embodiment, a first user and a second user may interact with system 200 using two different components.

With respect to the components of mobile device 222, user terminal 224, and cloud components 210, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 2, both mobile device 222 and user terminal 224 include a display upon which to display data (e.g., conversational response, queries, and/or notifications).

Additionally, as mobile device 222 and user terminal 224 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 200 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 2 also includes communication paths 228, 230, and 232. Communication paths 228, 230, and 232 may include the Internet, a mobile phone network, a mobile voice or data network (e.g., a 5G or LTE network), a cable network, a public switched telephone network, or other types of communications networks or combinations of communications networks. Communication paths 228, 230, and 232 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 210 may include the offline system 105, the serving system 110, and/or the data node 115. In some embodiments, cloud components 210 may implement one or more API endpoints, web services, and/or web resources described herein. Cloud components 210 may access the data node 115.

Cloud components 210 may include model 202 (e.g., production model 130 and/or generative model 135), which may be a machine learning model, artificial intelligence model, etc. (which may be referred collectively as “models” herein). Model 202 may take inputs 204 and provide outputs 206. The inputs may include multiple datasets, such as a training dataset and a test dataset. Each of the plurality of datasets (e.g., inputs 204) may include data subsets related to user data, predicted forecasts and/or errors, and/or actual forecasts and/or errors. In some embodiments, outputs 206 may be fed back to model 202 as input to train model 202 (e.g., alone or in conjunction with user indications of the accuracy of outputs 206, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a sequence of text, a reasoning trace, or the like).

In a variety of embodiments, model 202 may update its configurations (e.g., weights, biases, or other parameters) based on the assessment of its prediction (e.g., outputs 206) and reference feedback information (e.g., user indication of accuracy, reference labels, or other information). In a variety of embodiments, where model 202 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 202 may be trained to generate better predictions.

In some embodiments, model 202 may include an artificial neural network. In such embodiments, model 202 may include an input layer and one or more hidden layers. Each neural unit of model 202 may be connected with many other neural units of model 202. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 202 may be self-learning and trained, rather than explicitly programmed, and can perform significantly better in certain areas of problem solving, as compared to traditional computer programs. During training, an output layer of model 202 may correspond to a classification of model 202, and an input known to correspond to that classification may be input into an input layer of model 202 during training. During testing, an input without a known classification may be input into the input layer, and a determined classification may be output.

In some embodiments, model 202 may include multiple layers (e.g., where a signal path traverses from front layers to back layers). In some embodiments, back propagation techniques may be utilized by model 202 where forward stimulation is used to reset weights on the “front” neural units. In some embodiments, stimulation and inhibition for model 202 may be more free-flowing, with connections interacting in a more chaotic and complex fashion. During testing, an output layer of model 202 may indicate whether or not a given input corresponds to a classification of model 202.

In some embodiments, the model (e.g., model 202) may automatically perform actions based on outputs 206. In some embodiments, the model (e.g., model 202) may not perform any actions. The output of the model (e.g., model 202) may be used to allocate computing resources, execute code, execute a database query to insert or retrieve data from a database, adjust, issue, or cancel a security credential, or cause physical movement of a robotic system, among other examples, as described herein.

System 200 also includes API layer 250. API layer 250 may allow the system to generate summaries across different devices. In some embodiments, API layer 250 may be implemented on mobile device 222 or user terminal 224. Alternatively or additionally, API layer 250 may reside on one or more of cloud components 210. API layer 250 (which may be A REST or Web services API layer) may provide a decoupled interface to data and/or functionality of one or more applications. API layer 250 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 250 may use various architectural arrangements. For example, system 200 may be partially based on API layer 250, such that there is strong adoption of SOAP and RESTful Web-services, using resources like Service Repository and Developer Portal, but with low governance, standardization, and separation of concerns. Alternatively, system 200 may be fully based on API layer 250, such that separation of concerns between layers like API layer 250, services, and applications are in place.

In some embodiments, the system architecture may use a microservice approach. Such systems may use two types of layers: Front-End Layer and Back-End Layer where microservices reside. In this kind of architecture, the role of the API layer 250 may provide integration between Front-End and Back-End. In such cases, API layer 250 may use RESTful APIs (exposition to front-end or even communication between microservices). API layer 250 may use AMQP (e.g., Kafka, RabbitMQ, etc.). API layer 250 may use incipient usage of new communications protocols such as gRPC, Thrift, etc.

In some embodiments, the system architecture may use an open API approach. In such cases, API layer 250 may use commercial or open source API Platforms and their modules. API layer 250 may use a developer portal. API layer 250 may use strong security constraints applying WAF and DDoS protection, and API layer 250 may use RESTful APIs as standard for external integration.

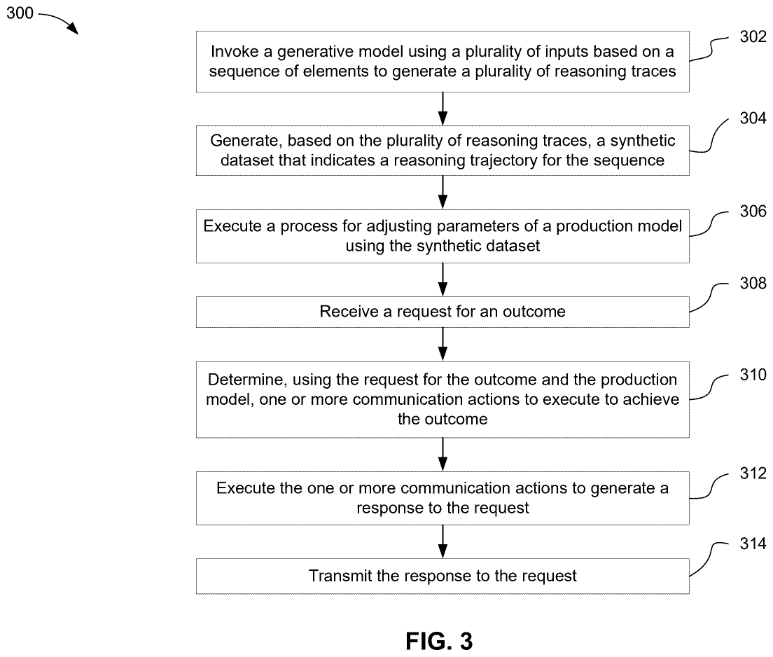

FIG. 3 shows a flowchart of the steps involved in managing request traffic in a system, in accordance with one or more embodiments. For example, the system may use process 300 (e.g., as implemented on one or more system components described above) in order to generate high-quality outputs for responding to requests made by user devices.

At step 302, process 300 (e.g., using one or more components described above) may include invoking a generative model using a plurality of inputs based on a sequence of elements to generate a plurality of reasoning traces. For example, the system may invoke a generative model using a plurality of inputs based on a sequence of elements to generate a plurality of reasoning traces. An input, of the plurality of inputs, may indicate an element of the sequence, and cumulative reasoning traces generated for any previous inputs of the plurality of inputs. As described in connection with reference number 155 of FIG. 1A, the sequence may indicate actions to achieve a particular outcome (e.g., that is editorially generated), and a generated reasoning trace for an action may include a planning step indicating that the action is to be used and/or a result of performing the action. In other examples, as described above, the sequence may indicate messages of a historical text interaction (e.g., a stored transcript of a text interaction between two parties), and a generated reasoning trace for a message may include a planning step indicating that an action is to be used and/or the action. By using cumulative reasoning traces that successively grow at each input to the generative model, contextual continuity is maintained for the generative model, thereby producing highly contextually relevant outputs from the generative model.

At step 304, process 300 (e.g., using one or more components described above) may include generating a synthetic dataset. For example, the system may generate a synthetic dataset, based on the plurality of reasoning traces, that indicates a reasoning trajectory for the sequence. As described in connection with reference number 160 of FIG. 1D, the reasoning trajectory may be a combination of the generated reasoning traces (e.g., in chronological order), which shows the reasoning that could be used by a model from a start to an end of the sequence. Thus, the reasoning trajectory provides reasoning annotations for the sequence that facilitates training a production model to use reasoning and actions when responding to a request, thereby enabling the production model to break down complex tasks, interact with external environments, and refine outputs dynamically. This enhances interpretability, reduces hallucinations, and improves adaptability by enabling the production model to iteratively reason through a problem before taking action.

Moreover, using the generative model to generate the synthetic dataset eliminates the need for editorial datasets that would otherwise be used to train the production model, which generally are not extensive enough to sufficiently train the production model and may contain errors that lead to the production model generating erroneous outputs. For example, the synthetic dataset can provide better training data than a manually-curated dataset by offering greater scalability, consistency, and control over data distribution, ensuring comprehensive coverage of edge cases and rare scenarios. In addition, the synthetic dataset eliminates biases and annotation errors, leading to cleaner and more uniform data. Additionally, the synthetic data can be generated in large quantities at lower cost, allowing for continuous model improvement without the limitations of manually-curated datasets.

At step 306, process 300 (e.g., using one or more components described above) may include executing a process for adjusting parameters of the production model using the synthetic dataset. For example, using the synthetic dataset, the system can fine tune the production model to use reasoning and actions to generate outputs, as described in connection with reference number 165 of FIG. 1D. The sequence(s) used, and therefore the synthetic dataset, may relate to a particular domain, thereby facilitating fine-tuning of the production model for that domain. For example, the domain may relate to chatbot functionality for a particular website, handling credentialing for a secure area (e.g., a secure area of a website or a physical area), or instructing physical movements of a robotics system. Fine-tuning the production model for a particular domain enhances the production model's performance by adapting it to domain-specific terminology, patterns, and nuances, leading to more accurate and contextually relevant outputs. Moreover, the fine-tuning may improve efficiency by reducing the need for extensive prompt engineering, which minimizes the amount of data included in requests made to the production model, thereby conserving network resources and processing resources used to communicate and process the data of the requests. Additionally, the fine-tuned production model can achieve higher accuracy with fewer computational resources compared to larger, more general models. The fine-tuned model may be deployed to handle online, real-time requests from user devices.

At step 308, process 300 (e.g., using one or more components described above) may include receiving a request for an outcome. For example, the system may receive the request for the outcome from a user device. As described in connection with reference number 175 of FIG. 1E, the request for the outcome may request computing resources to be allocated for the user device, may request execution of code, may request execution of a database query to insert or retrieve data from a database, may request adjustment, issuance, or cancellation of a security credential associated with the user device (e.g., a user of the user device), or may request a particular physical movement from a robotic system, among other examples. The request for the outcome may be received through a user interface (e.g., a question-and-answer system user interface, a chatbot user interface, a robotic system user interface, etc.). The user interface facilitates direct interaction between the user device and the production model. For instance, the system may capture and interpret user-entered text through an interface component designed to collect and manage inputs. The user interface can take various forms, such as a text box in a web application, a command-line interface, or a conversational agent window, allowing users to input requests (e.g., queries or prompts). When text is entered into this user interface, the system detects it as a prompt, and then processes this data for use by the production model. This setup ensures that the production model receives clear, structured prompts directly from the user device, facilitating accurate and timely responses based on the entered text.

At step 310, process 300 (e.g., using one or more components described above) may include determining one or more communication actions to execute to achieve the outcome. For example, the system, using the request for the outcome and the production model, may determine one or more communication actions to execute to achieve the outcome. As described in connection with reference number 180 of FIG. 1E, the production model may be invoked using the request for the outcome as input, thereby causing the production model to generate a response using reasoning. The reasoning may indicate actions, such as communication actions, that are to be performed in order to achieve the outcome. The communication actions involve communicating with other systems (e.g., via web pages, web services, databases, or the like) to retrieve data or perform actions in furtherance of the outcome. Due to being trained on the synthetic data, the production model may be able to generate relevant and efficient actions that can achieve the outcome, and the production model may do so with low latency suitable for online, real-time requests. The high-quality data and/or actions generated by the production model facilitates fewer request and response cycles between the system and the user device than would otherwise occur if less relevant and efficient actions were generated, thereby conserving processing resources and network resources.

At step 312, process 300 (e.g., using one or more components described above) may include executing the one or more communication actions to generate a response to the request. For example, as described in connection with reference number 185 of FIG. 1F, to execute the one or more actions, the system may transmit a server-side request to a resource, and receive a server-side response from the resource. The server-side request may request particular data and/or may request performance of a particular action or execution of a particular process. In some examples, executing the actions may allocate computing resources for the user device, may execute code, may execute a database query to insert or retrieve data from a database, or may adjust, issue, or cancel a security credential associated with the user device. Through the communication actions, the production model can access real-time or domain-specific information beyond its pre-trained knowledge, thereby enhancing the accuracy and relevance of the outputs produced by the production model. This approach reduces hallucinations and allows the production model to dynamically adapt to new data, improving decision-making in rapidly changing environments. Additionally, leveraging external data sources enables the production model to handle a wider range of requests without requiring frequent retraining, which consumes significant amounts of processing resources.

At step 314, process 300 (e.g., using one or more components described above) may include transmitting the response to the request. For example, the system may transmit the response to the request to the user device. The response, which is based on the results of the communication actions, may provide high-quality, relevant data to the user device and/or may indicate that relevant actions were performed in response to the request. Providing high-quality data and/or performing relevant actions to the request minimizes follow-up requests, thereby reducing the overall number of requests and responses that are exchanged. Thus, by delivering precise and contextually appropriate information on the first attempt, the system avoids redundant interactions that would otherwise be required to refine or correct the output. This efficiency improves system performance by lowering processing and network overhead, reducing latency, and optimizing resource utilization.

It is contemplated that the steps or descriptions of FIG. 3 may be used with any other embodiment of this disclosure. In addition, the steps and descriptions described in relation to FIG. 3 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 3.

In some implementations, an Application-Specific Integrated Circuit (ASIC) may be configured to perform operations described herein. An ASIC is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model's computations while ensuring efficient memory management and data movement. Because AI models, particularly deep learning networks, involve extensive matrix multiplications and tensor operations, specialized hardware units such as systolic arrays or tensor processing units (TPUs) can be integrated to optimize these operations. To overcome this challenge, the system may use weight quantization, memory hierarchy optimization, and on-chip interconnects can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC's capabilities, reducing inefficiencies and maximizing performance. By integrating specialized training accelerators, approximate computing methods, and efficient dataflow architectures, ASICs can be optimized for both training and inference, enabling large AI models to operate with minimal energy and latency constraints.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for managing request traffic in a system.
2. The method of embodiment 1, comprising: invoking, by one or more devices of the system, a generative model using a plurality of inputs based on a sequence of elements to generate a plurality of reasoning traces, wherein an input, of the plurality of inputs, indicates an element of the sequence, and cumulative reasoning traces generated for any previous inputs of the plurality of inputs; generating, by the one or more devices of the system and based on the plurality of reasoning traces, a synthetic dataset that indicates a reasoning trajectory for the sequence; executing, by the one or more devices of the system, a process for adjusting parameters of a production model using the synthetic dataset; receiving, by the one or more devices of the system and from a user device, a request for an outcome; determining, by the one or more devices of the system and using the request for the outcome and the production model, one or more communication actions to execute to achieve the outcome; executing, by the one or more devices of the system, the one or more communication actions to generate a response to the request; and transmitting, by the one or more devices of the system and to the user device, the response to the request.
3. The method of any of embodiments 1-2, wherein invoking the generative model comprises: generating a first input, of the plurality of inputs, based on a first element of the sequence, wherein the first input includes a first instruction to generate a first reasoning trace, of the plurality of reasoning traces, based on the first element; invoking the generative model using the first input to generate the first reasoning trace; generating a second input, of the plurality of inputs, based on a second element of the sequence, wherein the second input includes the first reasoning trace and a second instruction to generate a second reasoning trace, of the plurality of reasoning traces, based on the second element; and invoking the generative model using the second input to generate the second reasoning trace.
4. The method of any of embodiments 1-3, wherein the sequence of elements indicates actions to achieve a particular outcome, and wherein invoking the generative model comprises: invoking the generative model using a first input of the plurality of inputs, wherein the first input is based on a first action of the sequence; generating, using the generative model and based on the first input, a first reasoning trace of the plurality of reasoning traces, wherein the first reasoning trace indicates a first planning step and a first result corresponding to the first action; invoking the generative model using a second input of the plurality of inputs, wherein the second input is based on the first reasoning trace and a second action of the sequence; and generating, using the generative model and based on the second input, a second reasoning trace of the plurality of reasoning traces, wherein the second reasoning trace indicates a second planning step and a second result corresponding to the second action.
5. The method of any of embodiments 1-3, wherein the sequence of elements indicates messages of a historical text interaction, and wherein invoking the generative model comprises: invoking the generative model using a first input of the plurality of inputs, wherein the first input is based on a first message of the sequence; generating, using the generative model and based on the first input, a first reasoning trace of the plurality of reasoning traces, wherein the first reasoning trace indicates a first planning step and a first action corresponding to the first message; invoking the generative model using a second input of the plurality of inputs, wherein the second input is based on the first message, the first reasoning trace, a second message of the sequence, and a third message of the sequence; and generating, using the generative model and based on the second input, a second reasoning trace of the plurality of reasoning traces, wherein the second reasoning trace indicates a second planning step and a second action corresponding to the third message.
6. The method of embodiment 5, wherein generating the first reasoning trace comprises: generating the first reasoning trace and a response to the first input; discarding the response from the reasoning trajectory; and inserting the second message into the reasoning trajectory in place of the response.
7. The method of any of embodiments 1-6, further comprising: generating the plurality of reasoning traces using the generative model, wherein a reasoning trace, of the plurality of reasoning traces, indicates at least a planning step.
8. The method of any of embodiments 1-7, further comprising: retrieving a dataset that indicates the sequence of elements, wherein the sequence of elements indicates actions to achieve a particular outcome, or messages in a historical text interaction.
9. The method of any of embodiments 1-8, wherein determining the one or more communication actions to achieve the outcome comprises: determining one or more data sources to query for information used to generate the response, wherein the one or more communication actions include transmitting one or more queries to the one or more data sources.
10. The method of any of embodiments 1-9, wherein executing the one or more communication actions comprises: transmitting an application programming interface (API) request to an API endpoint; and receiving an API response via the API endpoint.
11. The method of embodiment 10, wherein transmitting the API request causes execution of an action that makes changes to an account associated with the user device.
12. The method of any of embodiments 10-11, wherein transmitting the API request causes adjustment, issuance, or cancellation of a security credential associated with the user device.
13. One or more non-transitory, computer-readable mediums storing instructions that, when executed by a data processing apparatus, cause the data processing apparatus to perform operations comprising those of any of embodiments 1-12.
14. A system comprising one or more processors; and memory storing instructions that, when executed by the processors, cause the processors to effectuate operations comprising those of any of embodiments 1-12.
15. A system comprising means for performing any of embodiments 1-12.

What is claimed is:

1. A system for deploying a model in a serving system that is configured to manage request traffic made in a network by user devices, the system comprising:
one or more memories; and
one or more processors, communicatively coupled to the one or more memories, configured to cause the system to:
retrieve, from one or more servers, a dataset that indicates a sequence of elements;
invoke a generative model using a plurality of inputs based on the sequence to generate a plurality of reasoning traces,
wherein an input, of the plurality of inputs, indicates an element of the sequence, and cumulative reasoning traces generated for any previous inputs of the plurality of inputs;
generate, based on the plurality of reasoning traces, a synthetic dataset that indicates a reasoning trajectory for the sequence;
execute a process for adjusting parameters of a production model using the synthetic dataset;
deploy, to a serving system, the production model with adjusted parameters for handling network requests from user devices;
receive, from a user device, a network request indicating a request for an outcome;
invoke the production model using the request for the outcome to determine one or more communication actions to execute to achieve the outcome;
execute the one or more communication actions to generate a response to the request; and
transmit, to the user device, a network response indicating the response to the request.

2. The system of claim 1, wherein the sequence of elements indicates actions to achieve a particular outcome, and wherein the one or more processors, to invoke the generative model, are configured to cause the system to:
invoke the generative model using a first input of the plurality of inputs,
wherein the first input is based on a first action of the sequence;
generate, using the generative model and based on the first input, a first reasoning trace of the plurality of reasoning traces,
wherein the first reasoning trace indicates a first planning step and a first result corresponding to the first action;
invoke the generative model using a second input of the plurality of inputs,
wherein the second input is based on the first reasoning trace and a second action of the sequence; and
generate, using the generative model and based on the second input, a second reasoning trace of the plurality of reasoning traces,
wherein the second reasoning trace indicates a second planning step and a second result corresponding to the second action.

3. The system of claim 1, wherein the sequence of elements indicates messages of a historical text interaction, and wherein the one or more processors, to invoke the generative model, are configured to cause the system to:
invoke the generative model using a first input of the plurality of inputs,
wherein the first input is based on a first message of the sequence;
generate, using the generative model and based on the first input, a first reasoning trace of the plurality of reasoning traces,
wherein the first reasoning trace indicates a first planning step and a first action corresponding to the first message;
invoke the generative model using a second input of the plurality of inputs,
wherein the second input is based on the first message, the first reasoning trace, a second message of the sequence, and a third message of the sequence; and
generate, using the generative model and based on the second input, a second reasoning trace of the plurality of reasoning traces,
wherein the second reasoning trace indicates a second planning step and a second action corresponding to the third message.

4. The system of claim 3, wherein the one or more processors, to generate the first reasoning trace, are configured to cause the system to:
generate the first reasoning trace and a response to the first input;
discard the response from the reasoning trajectory; and
insert the second message into the reasoning trajectory in place of the response.

5. The system of claim 1, wherein the one or more processors, to execute the one or more communication actions, are configured to cause the system to:
transmit an application programming interface (API) request to an API endpoint; and
receive an API response via the API endpoint.

6. The system of claim 5, wherein transmitting the API request is to cause execution of an action that makes changes to an account associated with the user device.

7. A method for managing request traffic in a system, the method comprising:
invoking, by one or more devices of the system, a generative model using a plurality of inputs based on a sequence of elements to generate a plurality of reasoning traces,
wherein an input, of the plurality of inputs, indicates an element of the sequence, and cumulative reasoning traces generated for any previous inputs of the plurality of inputs;
generating, by the one or more devices of the system and based on the plurality of reasoning traces, a synthetic dataset that indicates a reasoning trajectory for the sequence;
executing, by the one or more devices of the system, a process for adjusting parameters of a production model using the synthetic dataset;
receiving, by the one or more devices of the system and from a user device, a request for an outcome;
determining, by the one or more devices of the system and using the request for the outcome and the production model, one or more communication actions to execute to achieve the outcome;
executing, by the one or more devices of the system, the one or more communication actions to generate a response to the request; and
transmitting, by the one or more devices of the system and to the user device, the response to the request.

8. The method of claim 7, wherein invoking the generative model comprises:
generating a first input, of the plurality of inputs, based on a first element of the sequence,
wherein the first input includes a first instruction to generate a first reasoning trace, of the plurality of reasoning traces, based on the first element;
invoking the generative model using the first input to generate the first reasoning trace;
generating a second input, of the plurality of inputs, based on a second element of the sequence,
wherein the second input includes the first reasoning trace and a second instruction to generate a second reasoning trace, of the plurality of reasoning traces, based on the second element; and
invoking the generative model using the second input to generate the second reasoning trace.

9. The method of claim 7, wherein the sequence of elements indicates actions to achieve a particular outcome, and wherein invoking the generative model comprises:
invoking the generative model using a first input of the plurality of inputs,
wherein the first input is based on a first action of the sequence;
generating, using the generative model and based on the first input, a first reasoning trace of the plurality of reasoning traces,
wherein the first reasoning trace indicates a first planning step and a first result corresponding to the first action;
invoking the generative model using a second input of the plurality of inputs,
wherein the second input is based on the first reasoning trace and a second action of the sequence; and
generating, using the generative model and based on the second input, a second reasoning trace of the plurality of reasoning traces,
wherein the second reasoning trace indicates a second planning step and a second result corresponding to the second action.

10. The method of claim 7, wherein the sequence of elements indicates messages of a historical text interaction, and wherein invoking the generative model comprises:
invoking the generative model using a first input of the plurality of inputs,
wherein the first input is based on a first message of the sequence;
generating, using the generative model and based on the first input, a first reasoning trace of the plurality of reasoning traces,
wherein the first reasoning trace indicates a first planning step and a first action corresponding to the first message;
invoking the generative model using a second input of the plurality of inputs,
wherein the second input is based on the first message, the first reasoning trace, a second message of the sequence, and a third message of the sequence; and
generating, using the generative model and based on the second input, a second reasoning trace of the plurality of reasoning traces,
wherein the second reasoning trace indicates a second planning step and a second action corresponding to the third message.

11. The method of claim 10, wherein generating the first reasoning trace comprises:
generating the first reasoning trace and a response to the first input;
discarding the response from the reasoning trajectory; and
inserting the second message into the reasoning trajectory in place of the response.

12. The method of claim 7, further comprising:
generating the plurality of reasoning traces using the generative model,
wherein a reasoning trace, of the plurality of reasoning traces, indicates at least a planning step.

13. The method of claim 7, further comprising:
retrieving a dataset that indicates the sequence of elements,
wherein the sequence of elements indicates actions to achieve a particular outcome, or messages in a historical text interaction.

14. The method of claim 7, wherein determining the one or more communication actions to achieve the outcome comprises:
determining one or more data sources to query for information used to generate the response,
wherein the one or more communication actions include transmitting one or more queries to the one or more data sources.

15. The method of claim 7, wherein executing the one or more communication actions comprises:
transmitting an application programming interface (API) request to an API endpoint; and
receiving an API response via the API endpoint.

16. The method of claim 15, wherein transmitting the API request causes execution of an action that makes changes to an account associated with the user device.

17. The method of claim 15, wherein transmitting the API request causes adjustment, issuance, or cancellation of a security credential associated with the user device.

18. A non-transitory, computer-readable medium, comprising instructions that, when executed by one or more processors, cause operations comprising:
receiving a request for an outcome;
determining, using the request for the outcome and a production model, one or more actions to execute to achieve the outcome,
wherein the production model is trained using a synthetic dataset that indicates a reasoning trajectory for a sequence of elements that is based on a plurality of reasoning traces generated by a generative model for the sequence; and
executing the one or more actions to achieve the outcome.

19. The non-transitory, computer-readable medium of claim 18, wherein the instructions, when executed by the one or more processors, further cause operations comprising:
invoking the generative model using a plurality of inputs based on the sequence to generate the plurality of reasoning traces,
wherein an input, of the plurality of inputs, indicates an element of the sequence, and cumulative reasoning traces generated for any previous inputs of the plurality of inputs;
generating the synthetic dataset based on the plurality of reasoning traces; and
executing a process for adjusting parameters of the production model using the synthetic dataset.

20. The non-transitory, computer-readable medium of claim 18, wherein executing the one or more actions comprises:
transmitting an application programming interface (API) request to an API endpoint to cause adjustment, issuance, or cancellation of a security credential associated with a user device.
